(19) United States
(12) Patent Application Publication
(10) Pub. No.: US 2004/0134306 A1
(43) Pub. Date: Jul. 15, 2004

(54) Bi-material connecting rod

(76) Inventor: Fuping Liu, Plymouth, MI (US)

Correspondence Address: MCDONALD HOPKINS CO., LPA, 2100 BANK ONE CENTER, 600 SUPERIOR AVENUE, E., CLEVELAND, OH, 44114-2653, US

(21) Appl. No.: 10/341,945

(22) Filed: Jan. 14, 2003

(51) Int. Cl. G05G 1/00

(52) U.S. Cl. 74/579 R

(57) ABSTRACT

A bi-material connecting rod is disclosed herein. The connecting rod includes a crank end that formed from a first material, and a shank connected to the crank end that is formed from a second material. The connecting rod further includes a pin end adjacent to the shank and opposite from the crank end that can be formed from the first material, second powder-metal material, or a third material. Also disclosed herein is a method for making a bi-material connecting rod.

### FIELD OF THE INVENTION

The present invention relates to connecting rods. Particularly, the present invention relates to connecting rods having a first portion of the rod formed from a first composition and a second portion of the rod formed from a second composition for improved mechanical properties.

### BACKGROUND OF THE INVENTION

Connecting rods in engines transmit motion from a reciprocating part of the engine, such as a piston, to a rotating part of the engine, such as a crankshaft, and vice versa. A connecting rod includes a crank end portion, a shank or body portion, and a pin end portion. The crank end portion generally connects to the crankshaft whereas the pin end portion connects to the piston. Ideally, the material forming the crank end portion should exhibit relatively superior machinability and crackability properties, while fatigue and yield strength properties are not as critical. The crank end portion must exhibit superior machinability properties because several machining operations must be performed on the crank end during connecting rod production, including: grinding the thrust face at least once; turning the bore diameter; drilling and tapping bolt holes; and cracking the cap. Among those machining operations, drilling and tapping bolt holes present the major machinability challenges.

In addition, the dimensions at the crank portion are determined by factors such as the available space in the particular engine, and the ease of processing and machining. Although powder metallurgy can produce a connecting rod having a sintered body exhibiting excellent dimensional accuracy and having a complicated shape, parts requiring precision dimensional accuracy require a machining process, such as cutting or drilling after sintering. Accordingly, excellent machinability properties from the powdered metal, particularly the crank end material, is required and the dimensions at the crank end are not specifically determined based on any strength-related reasons.

The ideal material for the shank portion should exhibit superior fatigue and yield strength properties. However, machinability is not as critical for the material forming the shank portion, as the shank portion does not undergo the extensive machinability steps as does the crank portion. In the current production process, the only manufacturing steps generally performed on the shank portion are deflashing and shot peening.

By continuously developing new sintered metals of higher strength and thus also higher hardness, a lack of desirable machinability properties have become a major problem in the powder-metallurgical manufacture of components such as connecting rods. The lack of machinability properties are often a limiting factor when assessing whether powder-metallurgical manufacture is the most cost-effective method for manufacturing a component.

Many known powder-metal materials exhibit a fatigue strength higher than the typical materials used for forged powder-metal connecting rods. Such materials, however, are not widely used for high volume production of powder-metal connecting rods because of their poor machinability, the high costs associated with their powder premixes, the necessary processing of such metals, and their sensitivity to defects such as porosity and oxide penetration.

Among most of the materials utilized for forged powder-metal components, harder materials have less ductility. When the shank hardness is increased without a significant increase of ductility, the shank becomes more brittle and vulnerable to imperfections such as pores, an oxide network, and inclusion. As external tensile stress is applied to a connecting rod, the local stress at a defect such as a pore, oxide network, or inclusion reaches the tensile yield stress before the external stress does. Because the local high stress at a defect cannot be relaxed or maintained by dislocation activities such as nucleation, multiplication, interaction, reactions with grain boundaries and second phase, a crack will be nucleated. Once a crack is nucleated, crack propagation can occur quickly. The propagated crack remains sharp because of insufficient dislocation activities at the crack front so that the crack cannot become dull, resulting in fast propagation.

As a result, harder materials, in general, are more sensitive to defects. A skilled artisan should be concerned when a harder material is used to replace a softer material or a more brittle material is used to replace a more ductile material.

Of course, if the hard material also exhibits high ductility, it would be rare to result in a low fatigue endurance limit. Ductility, which is commonly measured from either elongation or reduction of cross sectional area by performing tensile testing, is dependent on loading rate, temperature, environment, and testing frequency. In general, high loading rate, low temperature, and high testing frequency result in more brittleness. However, there are exceptions to these general rules. Slip system changes, grain boundary ordering/disordering with temperature and loading fashion, hydrogen embrittlement, and corrosion crack nucleation and propagation can cause undesirable consequences. Also, undesirable consequences can occur when excessive residual stress, texture, quasi-equilibrium structure, etc., exist in materials.

It would be advantageous to improve the properties exhibited by the crank and shank portions of powder-metal connecting rods while lowering the overall costs associated with manufacturing powder-metal connecting rods.

It would further be advantageous to have a powder-metal connecting rod where the crank end material exhibits improved machinability properties whereas the shank exhibits improved strength properties.

### SUMMARY OF THE INVENTION

In one aspect, the present invention is directed to a connecting rod. The connecting rod includes crank end formed from a first material. The connecting rod further includes a shank connected to the crank end. The shank is formed from a second material. The connecting rod further includes a pin end connected to the shank and opposite from the crank end. Preferably, the pin end can be formed from the first material, second material, or a third material.

In another aspect, the present invention is also directed to a method of making a connecting rod. The method includes the step of inserting at least two powder-metal materials in a mold separated by a separator, preferably in the feeding shoe. The method also includes the step of compacting the materials to form a green body. The method further includes the step of sintering the green body to form a connecting rod.

Still other advantages and benefits of the invention will become apparent to those skilled in the art upon a reading and understanding of the following detailed description.

### BRIEF DESCRIPTION OF THE DRAWINGS

The invention may take physical form in certain parts and arrangements of parts, a preferred embodiment and method of which will be described in detail in this specification and illustrated in the accompanying drawings that form a part hereof, and wherein:

FIG. 1 is a perspective view of a connecting rod 10.

FIG. 2 is a perspective view of a feeding shoe ring 22 including a separator 26.

FIG. 3 shows a feeding apparatus 40 for feeding the shank and crank material to the feeding shoe 22.

FIGS. 4A, 4B and 4C show optical micrographs of the material transition zone for cross-sections A, B, and C from FIG. 1.

FIGS. 5A and 5B show optical micrographs of the microstructure of the shank material and crank material, respectively.

FIG. 6 shows an optical micrograph showing a material transition zone from the crank material to the shank material in a bi-material connecting rod at 100× magnification.

### DETAILED DESCRIPTION OF THE PREFERRED EMBODIMENT

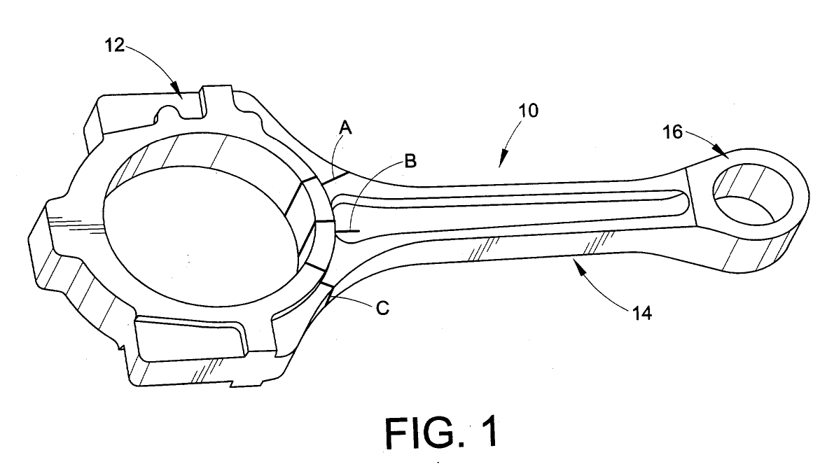

Referring now to the drawings, wherein the drawings are for the purposes of illustrating the preferred embodiment of the invention only and not for purposes of limiting same, FIG. 1 shows a connecting rod 10, including a crank end 12, a shank 14 and a pin end 16. The pin end 16 connects to a piston (not shown) and the crank end 12 connects to the crankshaft to translate power from the engine to the drive train. The crank end 12 is formed from a first material and the shank 14 is formed from a second material. The pin end 16 can be formed from the first material, the second material, or a third material.

Generally, it is preferred that the material properties forming the shank 14 and/or pin end 16 exhibit high-strength and low machinability. It is also generally preferred that the crank end 12 material exhibit relatively lower-strength and higher machinability properties than the shank 14 and/or pin end 16.

Material for the shank 14 can include any known powder-metal material. Preferably, the shank material includes an iron powder and further includes relatively smaller amounts of other constituents in order to achieve certain characteristics for processing and final high fatigue strength. The iron powder is in an amount of at least about 85% by weight of the shank material. Generally, the amount of iron powder will be the remainder of the premix depending on the amounts of the other constituents. Preferably, the base iron powder is prealloyed with 0.75-0.95% by weight molybdenum.

The shank material preferably includes copper in an amount of about 0.5 to 2.5% by weight, more preferably an amount of about 1.0 to 2.0% by weight. The addition of copper to the shank material is kept relatively low to avoid excessive brittleness.

The shank material further includes nickel. Nickel is preferably included into the shank material in an amount of about 1.0 to 5.0% by weight, more preferably an amount of about 2.0 to 4.0% by weight.

The shank material also includes graphite. Graphite is preferably included into the shank material in an amount of about 0.40 to 0.80% by weight, more preferably an amount of about 0.45 to 0.70% by weight. The amount of graphite is kept relatively low to avoid excess brittleness properties.

The shank material further includes a lubricant. The lubricant assists in the removal of the shank from the die during processing. The content of lubricant in the shank material is preferably in an amount of about 0.5 to 1.0% by weight, more preferably about 0.75% by weight.

Of course, it is contemplated by the inventor that manganese sulfide (MnS) may be included into the shank material. Preferably, no MnS is added to the shank material. Since MnS increases machinability and would require additional costs, MnS is not required in the shank material.

When formulating the shank material, it is important to avoid the possibility of the shank exhibiting too high a hardenability property, which would create excessive brittleness from defects such as porosity, oxide network or penetration, tears, and decarburization. There are at least two ways to reduce the vulnerability of a harder shank. One way to reduce the possibility of defects is by modifying the chemical composition of the shank material. Another way to reduce the possibility of defects is by tempering. If the hardenability property of the shank material is too low, a high performance connecting rod having high fatigue strength cannot be achieved. If the hardenability of the shank material is too high, however, distortion may exist and the shank material may be too brittle even after tempering. With a few exceptions, such as the secondary hardening of some tool steels, ductility can be increased while hardness and internal stresses can be reduced by tempering without a noticeable microstructure change.

The crank material differs from the shank premix. Since the crank end 12 requires more machining after sintering than does the shank 14, the crank material should exhibit better machinability properties than the shank material.

The crank material preferably includes at least about 90% by weight of an iron powder. The iron powdered can be prealloyed with a material, such as molybdenum, or any other prealloy material known in the art.

The crank material includes MnS, preferably in an amount of about 0.25 to 0.40% by weight, more preferably in an amount of about 0.30 to 0.35% by weight. The addition of MnS provides improved machinability properties to the crank.

The crank premix further includes graphite powder, preferably in an amount of about 0.4 to 0.7% by weight, more preferably from about 0.44 to 0.51% by weight. Using less graphite powder leads to diminished strength properties, whereas using too much graphite powder results in reduced machinability.

The crank material includes copper, preferably in an amount of about 1.0 to 3.0% by weight, more preferably an amount of about 1.80 to 2.20% by weight. The copper provides improved yield strength to the crank end without reducing machinability. The addition of too much copper, however, can reduce the machinability properties, cause copper segregation, and high sensitivity to defects in the crank.

The crank material further includes a lubricant. The lubricant facilitates the removal of the powder admixture from the die. The lubricant content in the crank material is preferably in an amount of about 0.5 to 1.0% by weight, more preferably in an amount of about 0.52 to 0.64% by weight.

It is preferred that the shank and crank materials exhibit similar apparent densities. Otherwise, the starting position of the shank and pin punches relative to the molding platform surface has to be adjusted in inverse proportion to the apparent density in order to maintain proper weight balance in a finished rod.

The pin end 16 can be formed from the shank material, the crank material, or from a third material different than the crank or shank material. Preferably, the material forming the pin end is the same as material forming the shank.

The connecting rod includes a material transition zone between the crank end and the shank. At the transition zone, the crank end material contacts the shank material. The cross-sectional area of the transition zone should be large enough to account for the fatigue strength difference between the crank end material and the shank material. Preferably, the cross-sectional area of the transition zone should meet the following formula:

Aₜ>(Sₛ/S_{c})·Aₘ (1)

where Aₜ is the cross-section of the transition zone; Sₛ and S_{c} are the fatigue endurance limits for shank material and crank material, respectively; and Aₘ is the area of the minimum cross section of the shank. If the cross-section of the transition zone does not meet this requirement, the crank end material near the transition zone could fail before the shank material.

Prior to sintering, the shank material and the crank material are connected at the material transition zone by mechanical interlocking, i.e., by the plastic deformation of the iron particles induced by compaction in a die. After sintering, the shank and crank materials are connected by reducing the oxide skin followed by interparticle bonding.

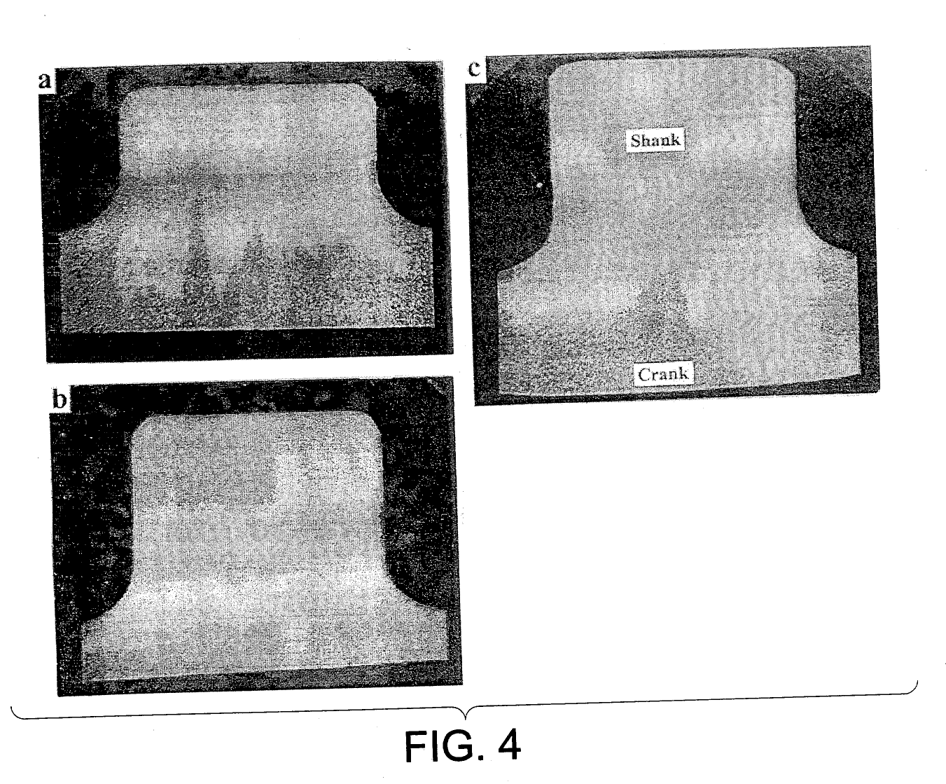

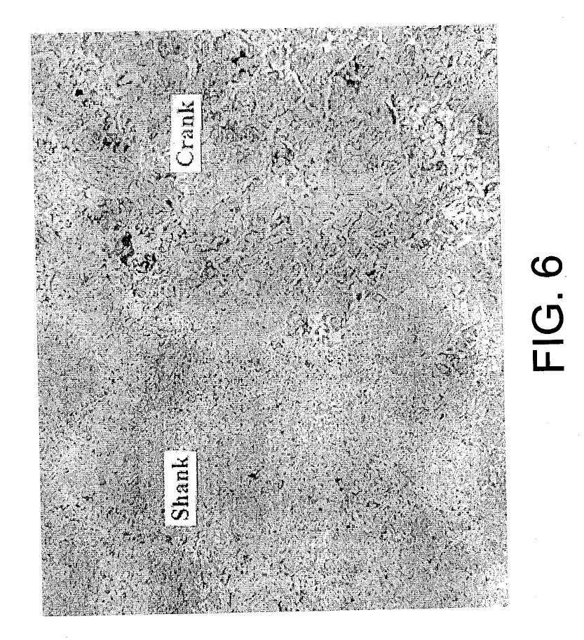

Preferably, the material transition zone has a zigzagged interface as shown in FIGS. 4A and 4B. The zigzagged interface for the transition zone provides a desired interlocking strength between the materials forming the crank end and shank. FIG. 6 shows the material transition zone between the crank end material and the shank material having a clear transition line, indicating that alloying elements do not diffuse over a measurable distance. It is emphasized that there are differences between the crank end and shank materials in dimensional changes upon molding ejection, delubrication, sintering, forging and subsequent cooling. These differences can create shear stress at the material transition zone so that a crack may be generated. During the entire manufacturing process, the shear stress at the material transition zone experiences three (3) maximums. The first maximum occurs upon green rod ejection from the molding dies because of different springbacks. The second maximum occurs during post-forging cooling between 1,300° F. and 1,100° F., when the crank material undergoes a phase transformation resulting in a dimensional expansion, while the shank material undergoes a more gradual dimensional shrinkage. The third maximum shear stress occurs in the later stage of post-forging cooling, i.e., between 600° F. and 300° F. when the shank material goes through a sudden expansion while the crank material experiences a gradual thermal shrinkage. Of course, if a different shank material is used, the parameters mentioned above could be very different.

Cracks can be avoided along the material transition line by modifying the copper and graphite additions in both the shank and crank end materials or by making the materials forming the shank and crank more similar to each other.

The considerations regarding the material transition zone would also apply to a transition zone between the pin end and the shank if the pin end is formed from crank material or any powder metal material different than the shank material.

The powder-metallurgical manufacturing process for forming a connecting rod includes the following steps. The base powder material, such as iron powder, for the shank and crank is mixed with desired alloying elements in a powder form. The powder mixture material is mixed with the lubricant prior to compacting. The shank material and crank material are fed into a die through pipes and a feeding shoe. The materials are compacted to form a green body having the general shape of the connecting rod. Compacting generally occurs at a pressure of 400-800 MPa. Higher compacting pressures can give only an insignificant increase in density but may increase tool wear. Lower compacting pressures may provide densities that are too low to be useful. The green body can be removed from the die and undergo a delubication process to remove excess lubricant. The green body is then sintered to form the connecting rod having its sintered strength, hardness, elongation, etc., properties. The sintering step generally occurs at a temperature of above 1050° C., preferably above 1100° C.

A normal metal-powder feeding system in the powder-metal industry is unable to feed two different powder premixes into the same connecting rod die as those systems are designed to only provide one premix to the die. Therefore, the conventional metal-powder feeding system must be modified in order to form the bi-material connecting rod of the present invention.

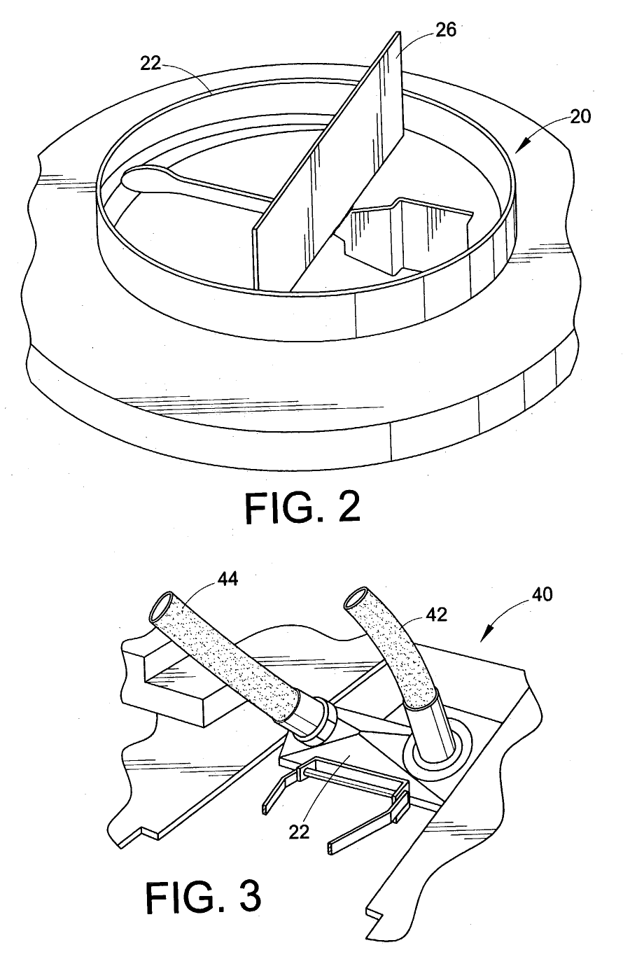

One modification that must be performed during the manufacturing process is the addition of a separator in the feeding shoe. The separator separates the shank material from the crank material. FIG. 2 shows a feeding shoe 20. The feeding shoe 20 includes a feeding shoe ring 22 and a separator 26. The separator 26 is preferably from about 0.001 to 0.01 inches thick (0.0245-0.254 mm), more preferably about 0.005 inches thick (0.127 mm). Preferably, the separator is welded to the feeding shoe ring 22. Specifically, the separator 26 is positioned above the parting line between the crank punch and the shank punch. In FIG. 2, since no separator is used between the shank and the pin end, the pin end 24 is filled with shank material. Of course, it is contemplated that an additional separator may be inserted in the mold between the shank and pin end so that the pin end would be filled with a material different than the shank, or anywhere else desired.

Under normal operations using only one material, the feeding shoe is fed with either one or two hoses carrying the same powder premix material from the same premix feeder (not shown). In order to feed the shank portion with a premix different than the premix for the crank portion, FIG. 3 shows a feeding apparatus 40 that includes a feeding hose 42 for feeding the shank premix composition to the shank and pin end, and a feeding hose 44 for feeding the crank premix material to the crank end of the feeding shoe ring 22. Of course, it is contemplated that an additional feeding hose or funnel may be added to the apparatus 40 for the addition of a pin end material if a material different from the shank material is desired.

During the manufacturing process, the connecting rod may undergo one or more steps in addition to the known powder metal compacting and sintering steps. Specifically, one preferred additional step during the manufacturing process is post-delubrication peening (PDP). The PDP step is set forth in U.S. patent application Ser. No. 09/653,889, filed on Sep. 1, 2000, incorporated herein by reference in its entirety. The PDP step can be particularly useful in decreasing the vulnerability of the shank and crank material, particularly the shank material, to imperfections such as pores and an oxide network within the material that would cause cracking. The PDP step essentially closes the surface and near-surface pores that act as channels for oxide penetration and decarburization prior to forging. Also, the PDP step eliminates surface and near-surface porosity on finished products, reduces the sensitivity of rod quality to processing variations, and heals cracks pre-existing in performs. Because PDP on bi-material rods reduces defects (porosity, oxide and decarburization) that can cause crack nucleation near the surface of the rod, the step of PDP may be more suitable on bi-material rods than on regular rods. Although the PDP step can further improve the properties exhibited by the connecting rod, the additional PDP step is not required.

Preferably, the green body formed after compacting should have the material transition line positioned at the separator location based on powder flow dynamics. An overflow of shank material into the crank area may impose machinability problems when grinding the thrust faces or turning the inner diameter bore of the crank if the overflow is beyond a certain range.

The present invention is illustrated in the following Example that is not limitive in scope.

### EXAMPLE

The pre-alloyed base iron powder and powder premix constituents for the shank premix composition are presented in Table 1. The base iron powder was prealloyed with 0.75-0.95% Mo. No MnS was added to the shank premix.

TABLE 1

| Additive | Trade Name | Supplier | Weight % |
|---|---|---|---|
| Base Iron | ATOMET 4401 | QMP | Balance |
| Copper | Royal 150 | US Bronze | 1.0-2.0 |
| Nickel | — | Alcan | 2.0-4.0 |
| Graphite | 3203 | Asbury | 0.45-0.70 |
| Lubricant | Acrawax C | Lonza | 0.75 |

Typical properties exhibited by the shank premix composition are shown in Table 2.

TABLE 2

| | |
|---|---|
| Flow Rate | 32.8 second/50 g |
| Apparent Density | 3.01 g/cm³ |
| Briquet Pressure for 6.8 g/cm³ | 77 KSI (521 MPa) |
| Green Strength at 6.8 g/cm³ | 2,160 psi (14.9 Mpa) |
| Sintered TRS | 138 KSI (952 Mpa) |
| Dimensional Change | +0.23% |
| Sintered Hardness | 60-90 Rb |

The constituents of crank material premix composition and typical premix properties are presented in Tables 3 and 4, respectively.

TABLE 3

| Constituent | Supplier | Product Name | Weight % |
|---|---|---|---|
| Copper | US Bronze | Royal 150 | 1.80-2.20 |
| Graphite | Southwestern | 1651 | 0.52-0.64 |
| Lubricant | Lonza | Acrawax C | 0.60-0.72 |
| Manganese Sulfide | Hogänäs | MnS-075 | 0.30-0.34 |
| Iron | Kobelco | 300ME | Balance |

TABLE 4

| | |
|---|---|
| Flow Rate | 29.6 second/50 g |
| Apparent Density | 2.98 g/cm³ |
| Briquet Pressure for 6.8 g/cm³ | 30 tsi (414 Mpa) |
| Green Strength at 6.8 g/cm³ | 1,204 psi (8.3 Mpa) |

Connecting rods from all considered blends were manufactured on the same production line and submitted for metallurgical evaluation, dimensional change measurements, tensile tests, fatigue tests, and machinability tests.

The shank and crank powder premix compositions were added to a feeding shoe including a separator for separating the two premixes. The shank premix composition was also used as the pin end premix composition. The compositions were then compacted to form the green body. The shank and crank materials are interconnected by a plastic deformation of iron particles at the material transition zone. The green body then underwent a delubrication step to remove excess lubricant. The shank and crank materials are interconnected by plastic deformation of iron particles at the transition.

After delubrication, bi-material rods were peened using a post-delubrication peening (PDP) step. As shown in Table 4, the shank material exhibited a high green strength to prevent damage by PDP.

For comparison, one hundred (100) regular single-material connecting rods and one hundred (100) bi-material connecting rods were sintered, forged, deflashed and peened under identical and normal production conditions.

Tensile testing was performed on dog bone-shaped specimens machined from rod shanks. A few rods were made with solely the shank powder in order to test the compressive yield strength of the shank material. Compressive testing was performed on cylinders machined from the bolt boss area of the rods. Staircase method with completely reversed loading (i.e., R=RHOₘₐₓ/RHOₘᵢₙ=−1, where RHOₘₐₓ/RHOₘᵢₙ are the maximum tensile stress and compressive stress, respectively) was used to perform fatigue testing on the finished connecting rods. Each fatigue test was terminated either upon the fracture of the specimens or after surviving 107 cycles (called “runout”).

Sectional densities of both the regular rods and the bi-material rods at each stage of processing are presented in Table 5.

TABLE 5

| | | | Bi-Material |
|---|---|---|---|
| Status of Rods | Location | Regular (in g/cm³) | (in g/cm³) |
| Compacted | Shank | 6.64 ± 0.01 | 6.51 ± 0.01 |
| | Pin | 6.89 ± 0.01 | 6.87 ± 0.03 |
| | Crank | 6.56 ± 0.17 | 6.47 ± 0.24 |
| Delubed | Shank | 6.64 ± 0.04 | 6.51 ± 0.04 |
| | Pin | 6.88 ± 0.03 | 6.84 ± 0.04 |
| | Crank | 6.67 ± 0.06 | 6.63 ± 0.06 |
| Forged | Shank | 7.83 ± 0.01 | 7.82 ± 0.01 |
| | Pin | 7.81 ± 0.01 | 7.82 ± 0.01 |
| | Crank | 7.81 ± 0.01 | 7.80 ± 0.01 |

Compacted and delubed densities of the pre-alloyed shank material are slightly lower because of its lower compressibility. Measured metallurgical properties of the two materials are presented in Table 6.

TABLE 6

| Property | Regular Shank | Bi-Material Shank |
|---|---|---|
| Core Hardness, Rg | 78.0-81.2 | 91.1-94.0 |
| Surface Hardness, Rg | 78.4-79.6 | — |
| Porosity | OK | OK |
| Oxide Penetration, mm | 0.07-0.09 | 0.04-0.05 |
| Total Decarburization, mm | 0.16-0.19 | 0.04-0.07 |
| Ferrite, % | 29-30 | 5-8 |

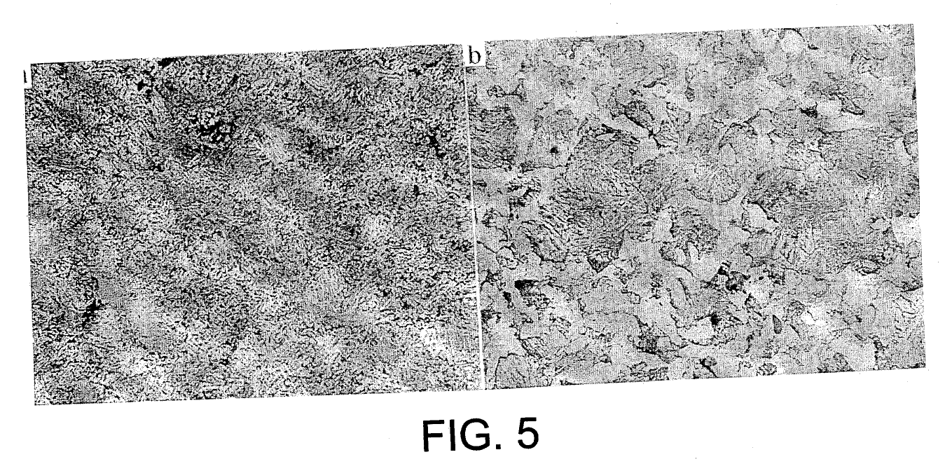

The bi-material rods were sectioned at sections “A”, “B” and “C” as schematically shown in FIG. 1. FIGS. 4A, 4B and 4C show Sections A, B, and C, respectively. At a high magnification, the microstructures of the shank material and the crank material are shown in FIGS. 5A and 5B. The material transition zone between the crank material and shank material is shown in FIG. 6. There are no noticeable defects at the interface. Therefore, mechanical integrity of the rod will not be affected due to the material transition.

Mechanical testing results of the conventional production connecting rod and the bi-material connecting rod are summarized in Table 7. The mechanical strength of the bi-material rod is significantly higher than that of the control production rod. However, the bi-material rod appears more brittle than the control production rod, represented by the low elongation (2.7-4.1%) of the bi-material rods versus the higher elongation (11-14%) exhibited the regular production rods.

TABLE 7

| Property | Regular | Bi-Material |
|---|---|---|
| Ultimate Tensile Strength, ksi | 122-130 | 240-252 |
| Yield Strength (0.2% offset) ksi | 78.3-79.6 | 159-171 |
| Elongation, % | 11-14 | 2.7-4.1 |
| Elastic Modulus, Mpsi | 27-29 | 29-30 |
| Poisson's Ratio | 0.27-0.30 | 0.30-0.32 |
| Compressive Yield Strength, ksi | 75.3-77.6 | 166-179 |
| Fatigue endurance Limit, ksi | 45 | 48-65 |

The shank material properties could be different from those in Tables 6 and 7 as other materials can be selected.

The invention has been described with reference to the preferred embodiment. Obviously, modifications and alterations will occur to others upon a reading and understanding of this specification. It is intended to include all such modifications and alterations insofar as they come within the scope of the appended claims or the equivalents thereof.

Having thus described the invention, it is claimed:

1. A connecting rod comprising;
a crank end formed from a first material;
a shank connected to said crank end, said shank formed from a second material;
a pin end connected to said shank and opposite from said crank end.

2. The connecting rod of claim 1 wherein said connecting rod further comprises a material transition zone between said crank end and said shank.

3. The connecting rod of claim 2 wherein said transition zone exhibits an appropriate cross-section area, Aₜ, based on a relation:
Aₜ>(Sₛ/S_{c})·Aₘ
where Sₛ is a fatigue strength of said second material, S_{c} is a fatigue strength of said first material, and Aₘ is a minimum cross-section area of said shank.

4. The connecting rod of claim 1 wherein said pin end is formed from said first material, said second material, or a third material.

5. The connecting rod of claim 4 wherein said pin end is formed from said second material.

6. The connecting rod of claim 4 wherein said pin end is formed from said first or said third material.

7. The connecting rod of claim 6 wherein said connecting rod further comprises a second material transition zone between said shank and said pin end.

8. The connecting rod of claim 1 wherein said second material lacks manganese sulfide.

9. The connecting rod of claim 1 wherein said first material contains manganese sulfide.

10. The connecting rod of claim 9 wherein said first material comprises from about 0.25-0.40% by weight of manganese sulfide.

11. A method for making a connecting rod comprising the following steps:
providing a feeding shoe having a separator;
inserting a first material and a second material in said shoe; and
compacting said materials.

12. The method of claim 11 wherein said first material forms a crank end of
said connecting rod and said second material forms a shank of said connecting rod.

13. The method of claim 11 further comprising the step of:
delubricating said materials after said compacting step to form a connecting rod.

14. The method of claim 13 further comprising the step of:
post-delubrication peening said materials.

15. The method of claim 11 further comprising:
sintering said materials after said compacting step to form a connecting rod.

16. The method of claim 12 further comprising:
machining said crank end after said compacting step to form a connecting rod.
